(19) United States
(12) Patent Application Publication
(10) Pub. No.: US 2011/0067089 A1
(43) Pub. Date: Mar. 17, 2011

(54) METHOD FOR SWITCHING A MOBILE TERMINAL FROM A FIRST ACCESS ROUTER TO A SECOND ACCESS ROUTER

(76) Inventors: Fabien Allard, Issy Les Moulineaux (FR); Julien Bournelle, Paris (FR); Jean-Michel Combes, Issy Les Moulineaux (FR)

(21) Appl. No.: 12/935,062

(22) PCT Filed: Mar. 30, 2009
(86) PCT No.: PCT/FR2009/050539

§ 371 Date: Nov. 24, 2010

(30) Foreign Application Priority Data
Mar. 31, 2008 (FR) 0852092

(51) Int. Cl. G06F 21/00

(52) U.S. Cl. 726/3

(57) ABSTRACT

A method of switching a mobile terminal from a first access router to a second access router, the terminal having previously set up a secure connection with the first access router with which is associated a communication context between the terminal and the first router, said context comprising at least one identifier relating to a set of security parameters of the connection. The invention relates to a method wherein said context is transferred to the second router while the terminal is switching, the method comprising, if the at least one identifier in the transferred context is already being used by said second router, a step of the second router sending the terminal a new identifier for said set of security parameters.

The present invention relates to the management of security when switching a mobile terminal from a first access router to which the terminal is initially securely connected to a second access router.

It is known in the art to set up a secure connection or secure tunnel between a terminal and an access router in order to make secure communications that are set up between the terminal and the access router. Such a tunnel may be set up using the IP security (IPsec) protocol. A stage of setting up this tunnel, called an IPsec tunnel, includes negotiation of security parameters necessary for making communications secure, for example keys to be used to encrypt communications between the two entities, cryptographic algorithms, etc. A protocol has been defined for negotiating security parameters when using the IPsec protocol. This is the Internet Key Exchange (IKE) protocol version 2 (IKEv2). To store and manipulate easily all the security parameters managed by the IKEv2 protocol and used by the mechanism for making communications secure, the IP security protocol uses the security association (SA) concept. By definition, a security association is a data structure that groups together all the parameters associated with a given secure connection between two peers: the security parameters negotiated in IKEv2 exchanges and IP addresses of source and destination peers involved in the communication, such as the terminal and the access router. A security associations database (SAD) stores all the security associations active at a given time. The elements stored in the SAD are created and modified by the IKEv2 protocol and then consulted using the IPsec protocol to find out how to process for security purposes a received packet or a packet to be sent. Such a database is present on each of the peers. In the security association database, a security association between the terminal and the access router is uniquely identified by an identifier known as the security parameter index (SPI).

On completion of IKEv2 security parameter negotiation, a communication context associated with the secure connection between the terminal and the access router is created in the access router and in the terminal. The communication context comprises the IPsec and IKEv2 parameters linked to the terminal and the access router: the security associations relating to communications between the terminal and the access router, their identifiers in the security association database, and a security policy that defines what must be done for security purposes to packets received or to be sent. The context thus comprises all the negotiated security parameters, the IP addresses of the terminal and the access router, and the security association identifiers (security parameter index (SPI)).

Thus when a mobile terminal is attached securely to a first access router, a first IPsec tunnel is set up and this IPsec tunnel is associated with a communication context comprising at least one security association identified by an index.

If this mobile terminal moves from a first area covered by this first access router to a second area covered by a second access router, a second IPsec tunnel must be set up between the mobile terminal and the second router. Setting up this second IPsec tunnel requires recommencing the exchange of IPsec messages from the beginning, notably the exchanges that relate to security parameter negotiation. Such an operation is time-consuming. With real-time services, for example a voice over IP service or a streaming video service, it may then be difficult to ensure continuity of service when the terminal is moving around.

To alleviate this problem it is known in the art to use a context transfer mechanism to transfer the IPsec and IKEv2 context relating to the mobile terminal from the first router to the second router. With the context transfer mechanism, the IPsec and IKEv2 context is then transferred from the first router to the second router when the terminal is moving around. However, for the context transfer to proceed correctly, in order to guarantee continuity of service, some parameters of the context received must be updated by the second router:
an IP address of the second access router towards which the terminal is moving;
an IP address of terminal which, acquires a new IP address when it is moving around;
where applicable, security association identifiers between the terminal and access router, if they are already being used in the second access router to identify other active security associations.

The existing MOBIKE (IKEv2 mobility and multi-homing) protocol is adapted to update and modify IP addresses of the access router and the terminal in security associations during context transfer. However, it is not possible to update security association identifiers if an identifier transferred in a context where a terminal moves from a first router to a second router is identical to an identifier being used by the second router. In such circumstances, the IPsec tunnel cannot benefit from the context transfer; it must therefore be reconstructed completely, which with real-time services makes it impossible to ensure continuity of service.

There is therefore a need to prevent the collision of security association identifiers between a terminal and an access router when transferring a context from a first access router to a second access router when the terminal is moving from the first access router to the second access router.

The invention addresses this need by proposing a method of switching a mobile terminal from a first access router to a second access router, the terminal having previously set up a secure connection with the first access router with which is associated a communication context between the terminal and the first router, said context including at least one identifier relating to a set of security parameters of the connection, in which method said context is transferred to the second router while the terminal is switching, characterized in that it includes, if the at least one identifier in the transferred context is already being used by said second router, a step of the second router sending the terminal a new identifier for said set of security parameters.

The method of the invention makes it possible to minimize the time necessary to switch a terminal from one access router to a second access router. This method makes it possible, during context transfer and in the event of collision between at least one security association identifier of the transferred context with one of the identifiers already being used by the second router to manage active security associations, to negotiate a new identifier between the terminal and the second router. This negotiation makes it possible to update the security parameters of the context and thus to set up a secure connection on the basis of updated context information. Thus it is not necessary to renegotiate the security parameters between the terminal and the second router from the beginning. It is therefore possible to guarantee continuity of services for real-time services being executed on the mobile terminal.

In one implementation of the invention, the method includes, if the new identifier received from the second router is already being used by the terminal, a step of sending the second router another new identifier for said set of security parameters.

A terminal that receives a proposed new identifier from the second access router is advantageously adapted to send the second router a counter-proposal if the new identifier received from the second router collides with an identifier already being used by the terminal.

The invention also provides a signal transporting a notification message intended to be transmitted between a terminal and a second router during switching of said terminal from a first router to said second router, the terminal having set up beforehand a secure connection with the first access router with which is associated a communication context between the terminal and the first router, said context including at least one identifier relating to a set of security parameters of the connection, said method including:
information relating to a collision between the identifier of said context and an identifier already being used by the second router; and
a new identifier intended to replace the identifier of the context.

In one embodiment of the invention, the message conforms to the IKEv2 protocol and is of the NOTIFY type.

The notification message used by a router to propose a new identifier to a terminal or by a terminal to send a router a counter-proposal containing another new identifier advantageously conforms to an existing message of a standardized protocol. Thus no new message needs to be defined.

The invention further provides an access router adapted to manage switching of a mobile terminal from a first access router to said access router, a secure connection having been set up between the terminal and the first access router, with which is associated a communication context between the terminal and said first router, said context including at least one identifier relating to a set of security parameters of the connection, said router including means for receiving said context while the terminal is switching, and being characterized in that it further includes:
detection means adapted to detect that the at least one identifier in the transferred context is already being used by said access router; and
sending means adapted to send the terminal a new identifier for said set of security parameters if the detection means detect that the at least one identifier in the transferred context is already being used by said access router.

The invention further provides a mobile terminal adapted to switch from a first access router to a second access router, said terminal being adapted to set up beforehand a secure connection with the first access router, with which is associated a communication context between the terminal and the first router, said context including at least one identifier relating to a set of security parameters of the connection, characterized in that it includes means for receiving and processing a new identifier sent by the second router adapted to substitute said new identifier for the identifier relating to the set of security parameters in the communication context during switching of the terminal to the second router.

In one embodiment of the invention, the terminal further includes:
detection means adapted to detect if the new identifier received from the second router is already being used by the terminal; and
generation and sending means adapted to generate and send the second router another new identifier for said set of security parameters commanded by said detection means.

The invention further provides a computer program for an access router, including:
code instructions for detecting if at least one identifier of the transferred context is already being used by the access router in the event of transfer to the router of a communication context associated with a secure connection between a terminal and another router and including at least one identifier relating to a set of security parameters of the connection; and
code instructions for commanding the sending to the terminal of a new identifier for said set of security parameters if the at least one identifier of the transferred context is already being used by said router, when the program is executed by a processor.

The invention further provides a data medium storing the computer program for an access router of the invention.

The invention further provides a computer program for a terminal including code instructions for replacing the identifier with a new identifier received from the second router in the event of transfer from a first router to a second router of a communication context associated with a secure connection between the terminal and the first router, the secure connection being associated with a communication context including at least one identifier relating to a set of security parameters of the connection, when the program is executed by a processor.

The invention further provides a data medium storing the computer program for a terminal of the invention.

Other features and advantages of the present invention can be better understood from the description of the method of one particular implementation of the invention of switching a mobile terminal from a first router to a second router, and from the appended drawings, in which:

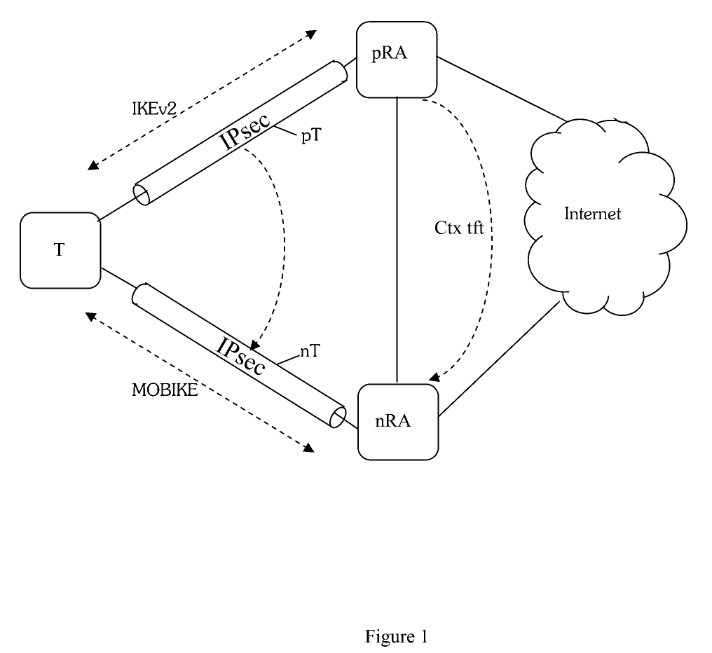

FIG. 1 shows the principle of transferring a communication context that is used by the invention;

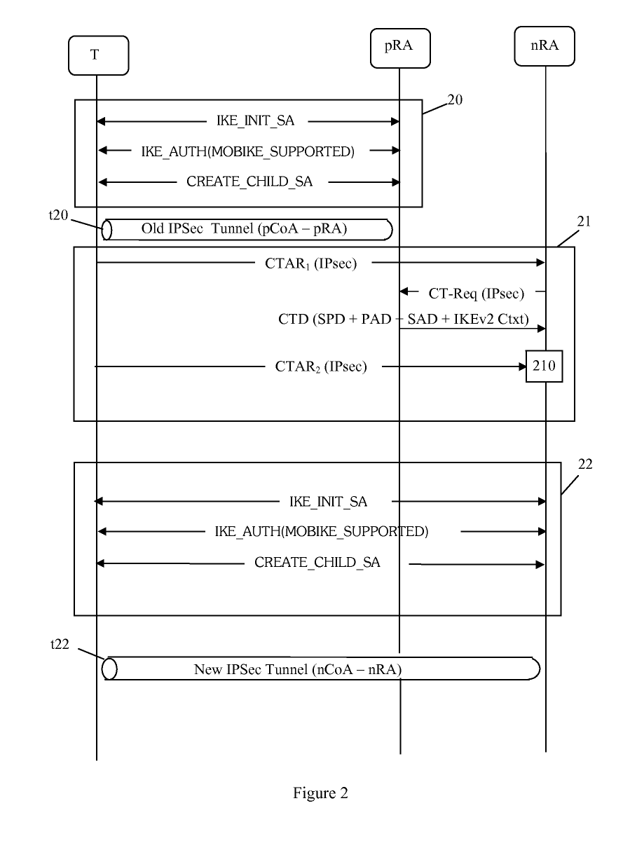

FIG. 2 shows messages exchanged during a prior art context transfer from a first router to a second router;

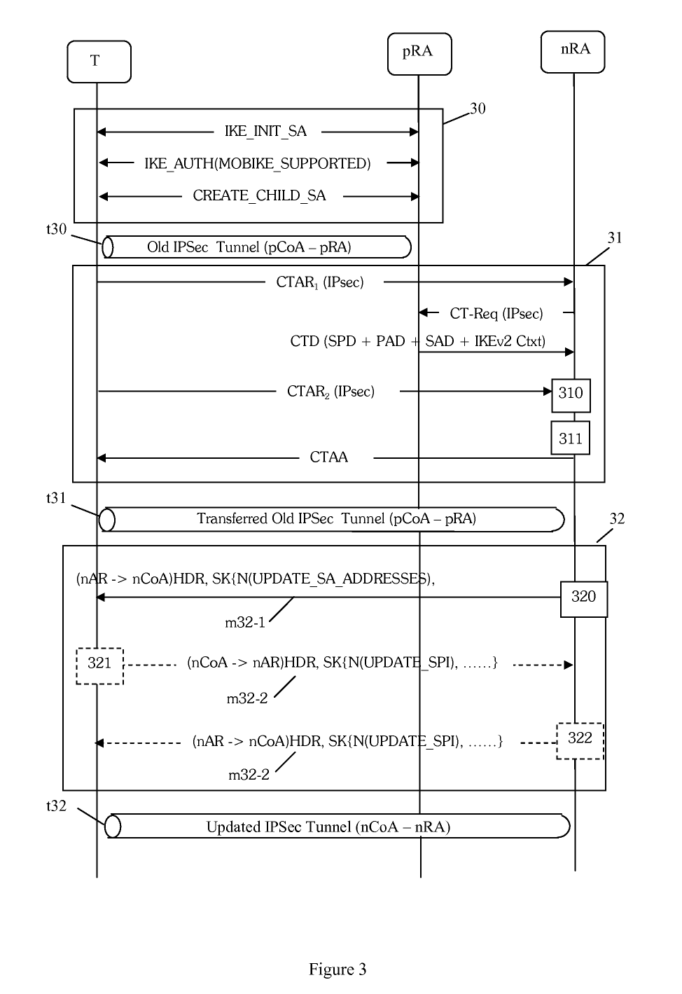

FIG. 3 shows the steps of the method of one particular implementation of the invention;

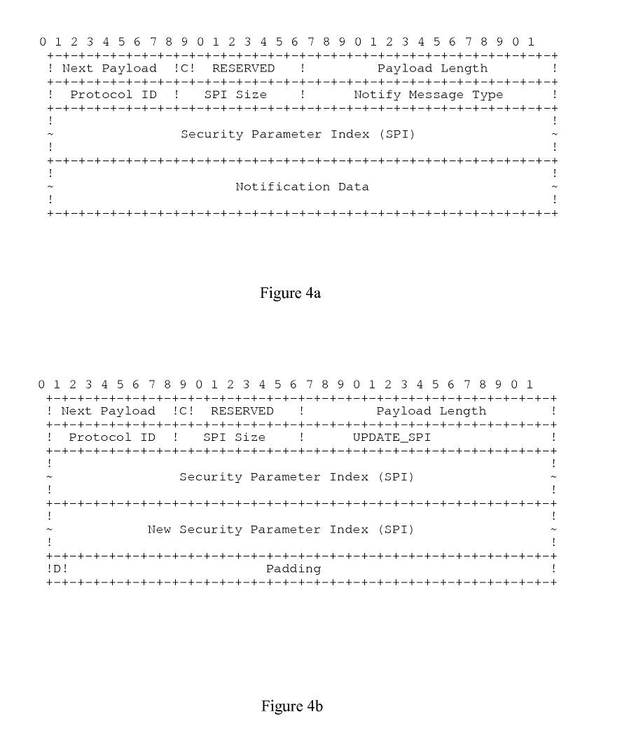

FIGS. 4a and 4b are respective diagrammatic representations of a structure of a prior art notification message, and of a notification message of one particular embodiment of the invention;

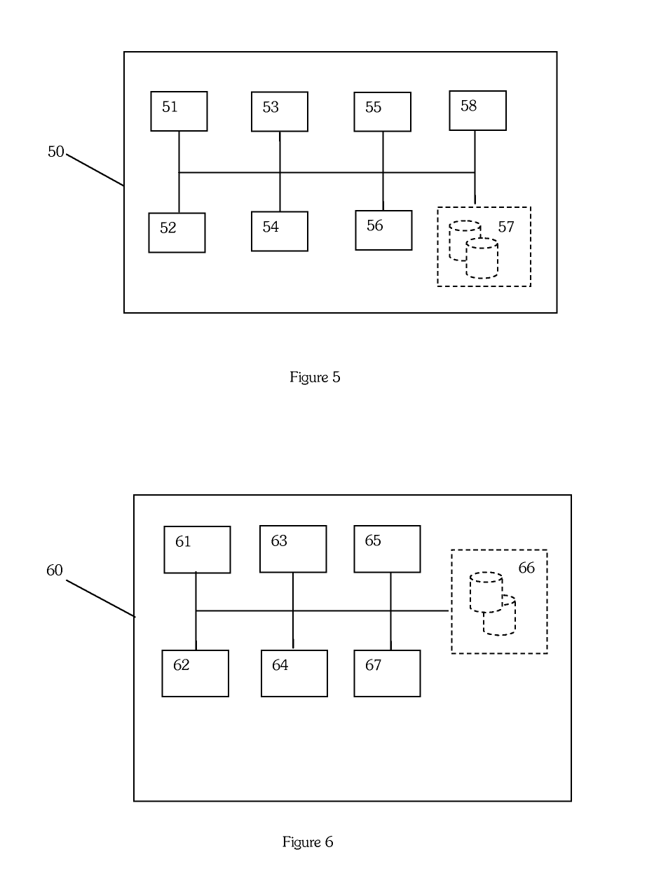

FIG. 5 is a functional block diagram of an access router of one embodiment of the invention; and

FIG. 6 is a functional block diagram of a terminal of one embodiment of the invention.

FIG. 1 illustrates a principle employed by the method of the invention. A mobile terminal T attached to an access router pRA accesses the Internet securely. To this end, the terminal T has set up a secure connection with the access router pRA represented in the figure by a tunnel pT between the terminal T and the access router pRA. The secure connection is set up using the IP security protocol (IPsec protocol), for example in tunnel mode. The IPsec tunnel pT makes it possible to secure communications between the mobile terminal T and the access router pRA. Protocol exchanges are necessary to set up the IPsec tunnel and include first exchanges for negotiating security parameters that are used to secure communications between the mobile terminal T and the access router pRA. The first exchanges for negotiating security parameters conform to the Internet Key Exchange (IKE) protocol version 2 (IKEv2), for example. The parameters negotiated during IKEv2 exchanges are for example cryptographic algorithms, encryption keys, a mode, for example tunnel mode, to be used to secure communications between peers, such as the terminal T and the access router pRA. It is also that during IKEv2 exchanges data structures known as security associations are defined. A security association is a data structure that groups together all the parameters associated with a given secure connection between two peers: the security parameters negotiated in IKEv2 exchanges and the IP addresses of the source and destination peers, respectively. Two types of security association are created during IKEv2 exchanges:
security associations used by the IPsec protocol, once the secure tunnel has been set up, to secure communications between peers; below these security associations are referred to as IPsec security associations;
security associations used by the KIEv2 protocol to protect IPsec security association negotiation; these security associations are referred to below as IKE security associations.

The security associations are stored in databases, not shown, in the terminal T and the access router pRA. The databases are known as security association databases (SAD). In these databases, each security association is uniquely identified by an identifier known as the security parameter index (SPI). It should be noted that a security association is directional: for a given peer, one security association is applied to reception of packets by that peer and another security association is applied to transmission of packets by that peer.

On completion of the IKEv2 security parameter negotiation, a communication context associated with the secure tunnel pT is created in the access router pRA and the terminal T. The communication context includes IPsec and IKEv2 parameters linked to the terminal T and to the access router pRA, to be more precise:
security associations relating to communications between the terminal and access router;
identifiers of those security associations; and
a security policy that defines what must be applied in terms of security to the packets received or to be sent.

Consider the example of a mobile terminal T which, when moving, detects a second access router nRA. The mobile terminal T decides, as a function of criteria that are specific to it, to access the network via the second access router nRA. To this end, the terminal T must both be detached from the router pRA by means of which it has been accessing the network until now and also be attached to the second router nRA. The terminal T is said to be switched from the router pRA to the second router nRA. To access the network via the second router nRA securely, the terminal T must set up a secure connection with the second access router nRA. This connection is represented by a tunnel nT. To limit the protocol exchanges between the mobile terminal T and the second access router nRA when setting up the secure connection between these two peers, a context is transferred comprising IKEv2 and IPsec parameters linked to the terminal T and to the first access router pRA. The transferred context comprises the security associations relating to communications between the terminal T and the first access router pRA, the identifiers of those security associations, and a security policy that defines what must be applied in terms of security to the packets received or to be sent.

The context transferred from the first router pRA to the second router nRA is represented by a dashed line arrow from the router pRA to the second router nRA. This context transfer between access routers makes it possible to set up a secure connection between the terminal T and the second router nRA without complete negotiation between the terminal T and the second router nRA, notably negotiation of security parameters using the IKEv2 protocol. The context that is transferred from the router pRA to the second router nRA is then activated on the second router nRA. This activation corresponds to placing the context on the second router nRA. The second router nRA then processes the context. In particular, the second router nRA updates the context:
a new IP address of the terminal T is specified, since by moving around, said terminal has acquired a new IP address;
an IP address of the access router to which the terminal T is attached is updated with the address of the second access router nRA;
if necessary, and in accordance with the invention, there is an updating of security association identifiers used to identify uniquely security associations between the terminal and the access router if those identifiers are already being used to identify other active security associations in the second router nRA. The method of updating the security association identifiers is described with reference to FIG. 3.

MOBIKE, an existing IKEv2 mobility and multi-homing protocol, is used to update the IP addresses of the router and the terminal.

Context transfer makes it possible to transfer from the router pRA to the second router nRA pertinent information that the second router nRA can use immediately. The context transfer saves time when switching the terminal T from the router pRA to the second router nRA.

In a situation, not shown, where there is no context transfer from the first router pRA to the second access router nRA, it is necessary to set up a secure connection between the mobile terminal T and the second access router nRA to restart the IKEv2 and IPsec protocol exchanges from the beginning in order to reconstruct the secure tunnel from the beginning.

The steps relating to switching a moving mobile terminal from one access router to a second access router in the prior art are described below with reference to FIG. 2.

In an initial step 20 during which the mobile terminal T is attached to the access route pRA, security parameters are negotiated between the terminal T and the router pRA to set up a secure connection with the access router pRA. The negotiation proceeds by exchanging IKEv2 protocol messages, which are not described in detail.

At the end of this negotiation, a communication context, not shown, is available in the mobile terminal T and the first access router pRA. The context comprises the IPsec and IKEv2 security associations associated with secure connections between the terminal T and the router pRA, the identifiers of the security associations, and a security policy that defines how to treat packets received or to be sent in terms of security. Thus the communication context between the terminal T and the access router pRA comprises security parameters necessary for securing communications between the terminal T and the access router pRA, the IP addresses of the terminal T and the access router pRA, and the SPI identifiers of the security associations in the security associations database SAD.

On completion of the initial step 20, a secure connection has been set up between the terminal T and the router pRA by means of an IPsec tunnel T20.

In a context transfer step 21 during which the mobile terminal T moves toward the second access router nRA, the communication context set up during the step 20 is transferred from the access router pRA to the second access router nRA. The transfer is effected by exchanging context transfer protocol (CXTP) messages, which are not described in detail, between the router pRA, the second router nRA, and the terminal T. The messages exchanged to transfer the communication context from the router pRA to the router nRA being known to the person skilled in the art and not being part of the invention, they are not described further here. The security associations are updated in the security association databases of the terminal T and the second access router nRA. In an attachment substep 210, following reception of a transfer activation request message CTAR₂, the terminal T is attached to the second access router nRA.

It is assumed here that the second access router nRA detects a collision between at least one of the security association identifiers received in the context and one of the security association identifiers that it is already using itself.

In a step 22 of attaching the terminal T to the second access router nRA, comparable to the initial step 20, security parameters are renegotiated between the terminal T and the second access router nRA. On completion of the attachment step 22, a secure connection has been set up between the terminal T and the second access router nRA. It is represented by a new tunnel t22. It should be noted that, in the prior art, setting up the new tunnel t22 requires restarting the IKEv2 protocol exchanges from the beginning.

In a situation, not shown, in which no collision between security association identifiers is detected by the second access router nRA in the attachment substep 210, the second access router nRA activates and processes the received context. It is considered that at this time the old tunnel that was securing communications between the terminal T and the router pRA has been transferred between the terminal T and the second access router nRA. However, the context associated with the transfer tunnel has not yet been updated. In a subsequent updating step, the second router nRA updates the communication context associated with the communication between the terminal T and the router nRA. To this end, MOBIKE protocol messages are exchanged between the second router nRA and the terminal T in order to update the IP addresses of the terminal T and the second router nRA in the security associations. The secure connection between the terminal T and the second router nRA has then been set up.

The steps of one specific implementation of the invention relating to switching a moving mobile terminal from one access router to a second access router are described below with reference to FIG. 3.

In an initial step 30, comparable to the step 20 in FIG. 2, the mobile terminal T is attached to the access router pRA. Security parameters are negotiated for setting up the secure connection between the terminal T and the access router pRA. On completion of the step 30, the communication context associated with the secure connection between the two peers has been defined in the mobile terminal T and the access router pRA.

On completion of the initial step 30, the secure connection has been set up between the terminal T and the router pRA by means of an IPsec tunnel t30.

Following movement of the mobile terminal T towards the second access router nRA, in a context transfer step 31, the communication context set up during the step 30 is transferred from the access router pRA to the second access router nRA. In an attachment substep 310, analogous to the attachment substep 210 in FIG. 2, and following reception of a transfer activation request message CTAR₂, the terminal T is attached to the second access router nRA. The second access router nRA detects a collision between at least one of the security association identifiers received in the communication context and one of the security association identifiers that it is already using. The collision may relate to one of more identifiers. The identifiers that it is already using correspond, for example, to secure connections that it has set up with other terminals, not shown. In a context activation substep 311, the second router nRA activates the received context and begins to process it.

The old IPsec tunnel t30 that was securing communications between the terminal T and the access router pRA is considered at this time to have been transferred between the terminal T and the second access router nRA. This tunnel is represented by a transferred old tunnel t31. However, the context associated with the transferred old tunnel t31 has not yet been updated.

In an updating step 32, the second access router nRA updates the communication context associated with the secure connection between the terminal T and the second access router nRA. To this end, MOBIKE protocol messages are exchanged between the second router nRA and the terminal T in order to update the IP addresses of the terminal T and the second access router nRA in the security associations associated with the secure connection and, according to the invention, in order to negotiate new security association identifiers between the terminal and the access router nRA, replacing the identifier or identifiers for which a collision has been detected. The object of negotiating new identifiers is to find security association identifiers for the secure communication between the terminal and the access router nRA that are not already being used by the second access router nRA and, where applicable, by the terminal T. to this end, in a substep 320 of sending a new identifier, an INFORMATIONAL type message m32-1 transporting at least one notification type data item is sent. The message m32-1 transports a peer IP address update notification N(UPDATE_SA_ADDRESSES) and as many N(UPDATE_SPI) notifications according to the invention, each comprising a new security association identifier, as there are identifiers detected as already being used during the attachment substep 310. The notification type data item of the invention is described with reference to FIG. 4b.

In an optional substep 321 of sending another new identifier, the terminal T that receives at least one security association identifier proposal in the message m32-1 detects a collision between the identifier received from the second access router nRA and a security association identifier that it is already using to manage a secure connection with another peer, not shown. The terminal then sends another new identifier proposal in a message m32-2 of the invention. It should be noted that the proposal relates to one or more identifiers according to whether there is a collision with one or more identifiers managed by the terminal T.

In an optional substep 322 corresponding to the situation where the second access router nRA detects a collision between identifiers on reception of the message m32-1, the router sends a proposal including at least one security association identifier in a message m32-3.

Where appropriate, sending new identifier proposals between the terminal T and the second access router nRA, not shown, continues until there are no more collisions between proposed identifiers and identifiers already being used or until a time-out expires. In this situation, a secure tunnel is reconstructed completely and security parameters are renegotiated from the beginning.

At the end of step 32, the negotiation of identifiers between the second access router nRA and the terminal T has ended successfully. New identifiers have been found for the security associations transferred in the context. The secure communication between the terminal T and the second router nRA has been set up, which is represented in the figure by a tunnel t32.

A message of the invention used to propose new security association identifiers in the event of collisions detected by the second router nRA during a context transfer from the access router pRA is described below with reference to FIGS. 4a and 4b.

FIG. 4a is a representation of an INFORMATIONAL type IKEv2 protocol message containing a NOTIFY type data item. Such a message is usually used during MOBIKE protocol exchanges to transmit a message relating to an error or a notification. Such a message may be sent to notify to a destination peer a new IP address of a sender peer, for example. In this situation, the notification sent uses an UPDATE_SA_ADDRESSES type.

If the FIG. 4a notification message concerns an existing security association, then its Protocol ID field specifies the type of security association: IKE or IPsec.

The SPI Size field specifies the length of the SPI or zero.

The Notify Message Type field specifies the type of notification message, for example UPDATE_SA_ADDRESSES.

The Security Parameter Index field contains the SPI.

Finally, the Notification Data field specifies the informational data item or the error transmitted in addition to the Notify Message Type.

A message of the invention, described with reference to FIG. 4b, defines a new type of notification adapted to enable a peer to propose a new security association identifier if it detects a collision between an identifier that it is already using and a security association identifier that it receives. A collision between identifiers may be detected during a context transfer from one access router to a second access router. In a different situation, detection may occur following the reception of a message conforming to the invention containing a proposal of a new identifier.

The message conforming to the invention is comparable to a notification message as described with reference to FIG. 4a. According to the invention, a new type UPDATE_SPI makes it possible to characterize the type of notification. A message of UPDATE_SPI type is adapted to propose a new security association identifier replacing an identifier already in use. The Security Parameter Index field contains the SPI identifier to be replaced.

The New Security Parameter Index field contains the new identifier, generated to prevent collision with the identifier of the Security Parameter Index field.

A directions flag D makes it possible to specify if the identifier to be modified is on the terminal side or the access router side. For example, the flag is coded on one bit and has the value 0 if it is on the terminal side or 1 if it is on the access router side.

If a collision is detected for a plurality of security association identifiers, the IKEv2 message contains a plurality of notifications of UPDATE_SPI type.

An access router of the invention is described below with reference to FIG. 5.

An access router 50 of the invention provides a basic router function: packet routing. As an access router, it enables a terminal to access one or more networks. It is conventionally adapted to set up a secure connection with the terminal that is attached to it to access the network. For example, secure connections are set up using the IPsec protocol. The router 50 of the invention is adapted to receive and to send to other routers communication contexts associated with secure connections set up with peers such as terminals. It is further adapted to negotiate with those peers new security association identifiers associated with the secure connections if it detects collisions between at least one identifier present in a context that it receives and one of the identifiers that it is already using to manage other secure connections with other peers. It is further adapted to receive from terminals attached to it and process proposals for new security association identifiers.

The access router 50 comprises a plurality of modules: network interfaces 51, a memory 52, a context reception and transfer module 53, a detection module 54, a module 55 for sending and receiving a proposal for at least one new security association identifier, a generation module 56, and databases 57. The modules 51, 52, 53, 54, 55, 56, and 57 are connected to a microprocessor 58:
the network interfaces 51 make it possible for a terminal or another access router to communicate with the access router 50 using various technologies, for example WiFi, WiMax, and further make it possible for the access router 50 to access one or more networks, for example the Internet, and thus to provide access to the network to the terminal or router that is attached to it;
the databases 57 are created dynamically when setting up secure connections between the router and peers; these bases comprise the security association database (SAD) and a security policy database (SPD) that defines what must applied in security terms to packets received or to be sent;
the memory 52 is used to effect calculations, to manage the databases 57, to load software instructions corresponding to the steps of the switching management method described above, and to have the software instructions executed by the microprocessor 58;
the microprocessor 58 or central processing unit (CPU);
a context reception and transfer module 53 adapted to receive from another access router a context associated with a secure communication set up beforehand between the other access router and the terminal and to transfer a context associated with a secure communication to another router;
a detection module 54 adapted to detect collisions between at least one of the security association identifiers received when transferring a context associated with one terminal from another router and one of the security association identifiers that it is already using, for example in the context of secure communications already set up with another terminal;
a module 55 for sending and receiving at least one new identifier proposal;
a generation module 56 adapted to generate at least one new identifier if the detection module 54 detects a collision between at least one identifier that it receives in a context that is transferred to it by another router or at least one identifier that it receives from a terminal in an identifier proposal and at least one identifier that it is already using; it is also adapted to generate a proposal relating to this at least one new identifier.

The send and receive modules 55 and the generation module 56 cooperate to send a new security association identifier if a collision is detected by the detection module 54.

The modules 53, 54, 55, and 56 are adapted to execute those of the steps of the switching method described above that are executed by the access router. They are preferably software modules comprising software instructions for executing the steps of the switching method described above that are executed by a processor of an access router.

The invention thus also relates to:
a computer program including instructions for executing the switching method as described above when this program is executed by a processor;
a storage medium readable by an access router storing the computer program described above.

The software modules may be stored in or transmitted by a data medium. This may be a hardware storage medium, for example a CD-ROM, a magnetic diskette or a hard disk, or a transmission medium such as a signal or a telecommunications network.

A mobile terminal of the invention is described below with reference to FIG. 6.

A mobile terminal 60 of the invention has standard network access functions, for example Internet access functions, entailing attachment to an access router. Conventionally, the mobile terminal 60 is adapted to set up a secure connection with an access router to which it is attached.

The mobile terminal 60 comprises a plurality of modules: network interfaces 61, a memory 62, a module 63 for receiving and processing a new security association identifier, a module 64 for generating and sending a new security association identifier, a detection module 65, and databases 66. The modules 61, 62, 63, 64, 65, and 66 are connected to a microprocessor 67:
the network interfaces 61 are adapted to access a network by attachment to access routers and to detect the presence of access routers in a geographical area; the attachment to an access router may be effected using various technologies, for example WiFi;
the databases 66 are created dynamically when setting up secure connections between the terminal and routers; these databases include the security association database SAD and a security policy database SPD that defines what, in security terms, must be applied to the packets received or to be sent;
the memory 62 makes it possible to effect calculations, to manage the databases 66, to load software instructions corresponding to the steps of the method of processing a new identifier by the mobile terminal described above, and to have them executed by the microprocessor 67
the microprocessor 67 or central processor unit (CPU);
the module 63 for receiving and processing a new identifier is adapted, when switching the terminal from a first router to a second router and if a collision between security association identifiers relating to a set of security parameters is detected, to receive a new identifier transmitted by this second router and to substitute it for an identifier used by the terminal for a security association in the security association database;
the module 64 for generating and sending a new identifier is adapted to generate and to send, where necessary, a new identifier to the access router if the identifier received from the access router is already being used by the terminal to identify an active security association;
the detection module 65 is adapted to detect, on reception of a security association identifier sent by an access router, that the identifier is already being used by the terminal to identify an active security association;
the modules 63, 64, and 65 are adapted to execute those of the steps described above of the switching method that are executed by the mobile terminal; they are preferably software modules comprising software instructions for executing the steps of the method of switching a mobile terminal that are executed by the terminal.

The invention thus also relates to:
a computer program including instructions for executing the switching method as described above when this program is executed by a processor;
a storage medium readable by a node storing the computer program described above.

The software modules may be stored in or transmitted by a data medium. This may be a hardware storage medium, for example a CD-ROM, a magnetic diskette or a hard disk, or a transmission medium such as a signal or a telecommunications network.

1. A method of switching a mobile terminal from a first access router to a second access router, the terminal having previously set up a secure connection with the first access router with which is associated a communication context between the terminal and the first router, said context comprising at least one identifier relating to a set of security parameters of the connection, in which method said context is transferred to the second router while the terminal is switching, the method comprising:
if the at least one identifier in the transferred context is already being used by said second router, a step of the second router sending the terminal a new identifier for said set of security parameters, and
if the new identifier received from the second router is already being used by the terminal, a step of sending the second router another new identifier for said set of security parameters.

2. (canceled)

3. A method for transmitting a signal transporting a notification message transmitted between a terminal and a second router during switching of said terminal from a first router to said second router, the terminal having set up beforehand a secure connection with the first access router with which is associated a communication context between the terminal and the first router, said context comprising at least one identifier relating to a set of security parameters of the connection, said method comprising:
providing information relating to a collision between the identifier of said context and an identifier already being used by the second router; and
providing a new identifier to replace the identifier of the context.

4. A method for transmitting a message according to claim 3, wherein the message conforms to the IKEv2 protocol and is of the NOTIFY type.

5. An access router that manages switching of a mobile terminal from a first access router to said access router, a secure connection having been set up between the terminal and the first access router, with which is associated a communication context between the terminal and said first router, said context comprising at least one identifier relating to a set of security parameters of the connection, said router comprising means for receiving said context while the terminal is switching, the router further comprising:
detection means that detects that the at least one identifier in the transferred context is already being used by said access router; and
sending and receiving means that send the terminal a new identifier for said set of security parameters if the detection means detect that the at least one identifier in the transferred context is already being used by said access router, and receive from the terminal a new identifier for said set of security parameters if the new identifier sent is already being used by the terminal.

6. A mobile terminal that switches from a first access router to a second access router, said terminal being adapted to set up beforehand a secure connection with the first access router, with which is associated a communication context between the terminal and the first router, said context comprising at least one identifier relating to a set of security parameters of the connection, the terminal comprising:
means for receiving and processing a new identifier sent by the second router adapted to substitute said new identifier for the identifier relating to the set of security parameters in the communication context during switching of the terminal to the second router;
detection means that detects if the new identifier received from the second router is already being used by the terminal; and
generation and sending means that generate and send the second router another new identifier for said set of security parameters commanded by said detection means.

7. (canceled)

8. A non-transitory computer program product for an access router, comprising program code instructions stored on a computer-readable medium, comprising computer-readable programming means for:
detecting if the at least one transferred context identifier is already being used by said access router when transferring to the router a communication context associated with a secure connection between a terminal and another router and comprising at least one identifier relating to a set of security parameters of the connection;
commanding the sending to the terminal of a new identifier for said set of security parameters if the at least one identifier of the transferred context is already being used by said router; and
commanding the receiving of another new identifier for said set of security parameters if the new identifier sent is already being used by the terminal;
when said program is executed on a computer.

9. (canceled)

10. A non-transitory computer program product for a terminal, including program code instructions stored on a computer-readable medium, comprising computer-readable programming means for;
replacing said identifier by a new identifier received from the second router in the event of transfer from a first router to a second router of a communication context associated with a secure connection between the terminal and the first router, the secure connection being associated with a communication context including at least one identifier relating to a set of security parameters of the connection when said program is executed on a computer;
detecting if the new identifier received from the second router is already being used by the terminal; and
generating and sending the second router another new identifier for said set of security parameters if the new identifier received from the second router is already being used by the terminal;
when said program is executed on a computer.

11. (canceled)
